(19) United States
(12) Patent Application Publication
(10) Pub. No.: US 2015/0101563 A1
(43) Pub. Date: Apr. 16, 2015

(54) METHOD AND APPARATUS FOR SEQUENTIAL CONTROL OF AIR INTAKE COMPONENTS OF A GAS-FUELED COMPRESSION IGNITION ENGINE

(71) Applicant: Clean Air Power, Inc., Poway, CA (US)

(72) Inventors: Hoi Ching Wong, San Diego, CA (US); John Headley, San Diego, CA (US)

(21) Appl. No.: 14/396,117

(22) PCT Filed: Apr. 3, 2013
(86) PCT No.: PCT/US13/35099

§ 371 Date: Oct. 22, 2014

Related U.S. Application Data
(60) Provisional application No. 61/652,927, filed on May 30, 2012.

(51) Int. Cl. F02M 35/10; F02D 41/00; F02B 9/04

(52) U.S. Cl. CPC F02M 35/10078; F02B 9/04; F02D 41/0002
USPC 123/27 GE; 123/344

(57) ABSTRACT

A method of controlling components in an air intake system for an internal combustion engine (10) uses sequential control. The method includes sequentially controlling the operation of a plurality of components (130, 132, 134) of an air intake system to control an excess air ratio for the engine, including identifying a deviation between an actual value of a parameter indicative of an excess air ratio and a desired value, controlling the first component (130) at a first time, and controlling the second component (132) at a second time that is later than the first time. The controlled components may be a turbo air bypass valve and a turbo wastegate valve.

CROSS REFERENCE TO A RELATED APPLICATION The present application claims priority under 35 USC §1.119(e) to United States Provisional Patent Application Ser. No. 61/652,927, filed May 30, 2012 and entitled “METHOD AND APPARATUS FOR SEQUENTIAL CONTROL OF AIR INTAKE COMPONENTS FO A GAS-FUELED COMPRESSION IGNITION ENGINE,” the subject matter which is hereby incorporated by reference in its entirety.

### BACKGROUND OF THE IN ELATION

1. Field of the Invention

This invention relates generally to a control system and method for an air induction system of an internal combustion engine, and, more particularly, relates to a control system and method for an air induction system that controls an excess air ratio (lambda) for a gas-fueled compression ignition engine by coordinating control of a plurality of components in the air induction system.

2.Discussion of the Related Art

Recent years have seen an increased demand for the use of gaseous fuels as fuel source in internal combustion engines. Gaseous fuels such as propane or natural gas are considered by many to be superior to diesel fuel and the like as a fuel source for compression ignition engines because gaseous fuels are generally less expensive, provide equal or greater power with equal or better mileage, and produce significantly lower emissions. This last benefit renders gaseous fuels particularly attractive because recently enacted and pending worldwide regulations may tend to prohibit the exclusive use of diesel fuel in many engines. In addition, adapting an engine to be fueled at least in part by gaseous fuels can significantly reduce an engine's carbon footprint, particularly if the gaseous fuel is obtained from biomass or another carbon-neutral source. The attractiveness of gaseous fuels is further enhanced by the fact that existing compression ignition engine designs can be readily adapted to burn gaseous fuels.

When used to fuel compression ignition engines, the relatively compressible gaseous fuel typically is ignited through the auto-ignition of a “pilot charge” of a relatively incompressible fuel, such as diesel fuel, that is better capable of compression ignition. Engines fueled on a part or full range basis by a pilot ignited gaseous fuel charge often are called “dual fuel engines.” Dual fuel engines that are additionally capable of operating in one or more other modes, such as a “diesel only” mode in which the engine is selectively capable of being fueled solely by diesel fuel, often are referred to as “multimode engines.”

Lean bum engines, including standard diesel engines and dual fuel engines, have a wide range of desired excess air ratios or “lambdas” as compared to a gasoline engine, which generally operates in a small band around the stochiometric (lambda=1). In a dual fuel engine, the optimal lambda may vary between about 1.2 and 1.6 depending on conditions such as speed and load. Such systems control fuel and/or air supply to achieve or maintain an experimentally determined ideal lambda for prevailing speed and load conditions and possibly for other conditions as well. These engines typically have a turbocharger that includes a turbine that is driven by the engine's exhaust gases and a compressor that is powered by the turbine to increase or “boost” the pressure of the intake airstream. The amount of boost can be controlled to maintain lambda values within a permissible range and even to cause lambda values to approach optimum levels.

The amount of boost provided by a turbocharger may be controlled, for example, through the operation of either or both of a turbo air bypass valve or “TAB valve” and a turbo wastegate valve. A TAB valve functions to divert a portion of compressed air flow away from engine back to the compressor inlet, hence to reduce the boost. A turbo wastegate valve diverts exhaust gases from the feed line to the turbine of the turbocharger to reduce the available boost. However, in practice, only one of these devices typically is used at any given time because the control of both devices is complicated. Most notably, if both devices were to be controlled at once, it would be impossible to determine the relative effect of the adjustment of each control on the end result. This lack of certainty necessarily hampers precise lambda control.

Further, although fuel consumption is improved at steady load and speed by controlling lambda using turbo wastegate control with the TAB valve disabled, the use of wastegate for lambda control may introduce “compressor lag” similar to “turbo lag” during the transient operation, acceleration and deceleration. This turbo lag results in a delay in achieving the desired lambda of the engine. This delay is particularly troubling during transient conditions when the desired lambda is changing frequently and/or sharply.

### SUMMARY OF THE INVENTION

In accordance with a preferred aspect of the invention, a method of controlling components in an air intake system for an internal combustion engine uses sequential control. The method includes sequentially controlling the operation of a plurality of components of an air intake system to control an excess air ratio (lambda) for the engine. The method includes identifying a deviation between an actual value of a parameter indicative of an excess air ratio and a desired value of that parameter, controlling a first component of the air intake system at a first time, and controlling a second component of the air intake system at a second time that is later than the first time. The components may, for example, be a TAB valve and a wastegate valve. Other component(s), such as a throttle, may be controlled instead of or in addition to one or both of these components.

Also disclosed is a system implementing a method at least as substantially described herein.

These and other objects, advantages, and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

A preferred exemplary embodiment of the invention is illustrated in the accompanying drawings in which like reference numerals represent like parts throughout, and in which:

FIG. 1 schematically represents an engine constructed and controlled in accordance with an embodiment of the present invention;

FIG. 2 is a partially schematic sectional side elevation view of a cylinder of the engine of FIG. 1 and of associated engine components;

FIG. 3 schematically represents an air intake control system constructed and controlled in accordance with a preferred embodiment of the present invention;

FIG. 4 is a schematic control diagram of the engine of FIGS. 1 and 2 and of its attendant controllers and sensors; and

FIG. 5 is a flowchart illustrating a preferred computer-implemented process for controlling an excess air ratio in the engine of FIG. 1 using sequential control of the air intake control system of FIG. 3.

FIGS. 6A and 6B collectively form a flowchart illustrating preferred computer-implemented process for controlling excess air ration using sequential control of three (3) air intake control system.

### DETAILED DESCRIPTION OF THE PREFERRED EMBODIMENTS

The system and method for using sequential control of components of an air intake control system concepts described herein are applicable to a variety of lean burn engines that are fueled at least in part by a gaseous fuel and in which it is desirable to control an excess air ratio. Hence, while a preferred embodiment of the invention will now be described in conjunction with a dual fuel compression ignition engine, it is usable with a variety of other lean burn gaseous fueled engines as well.

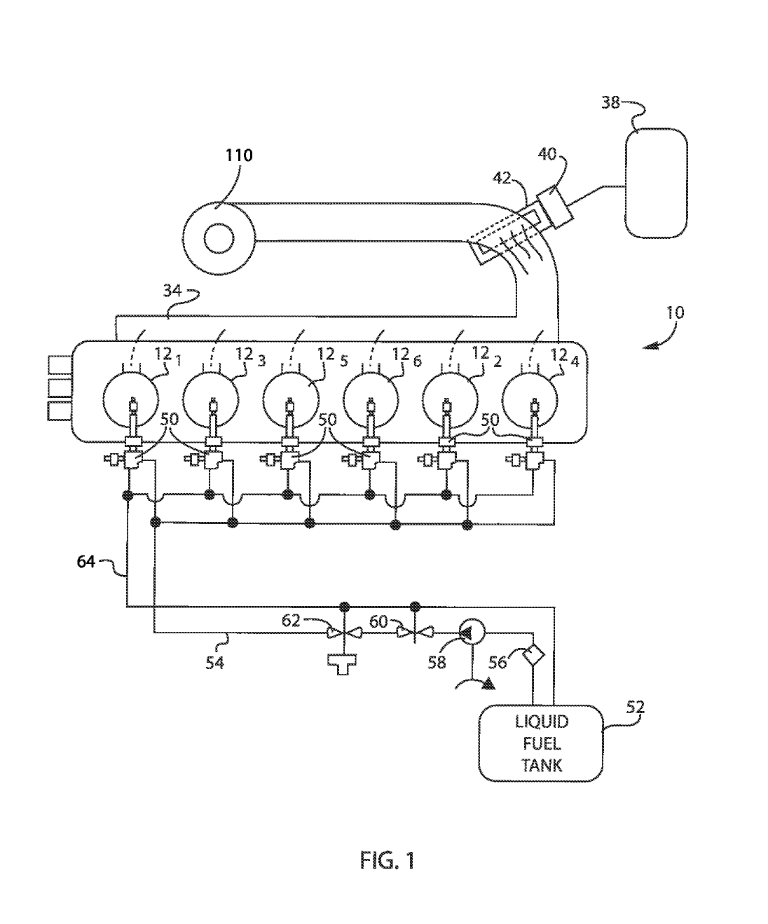

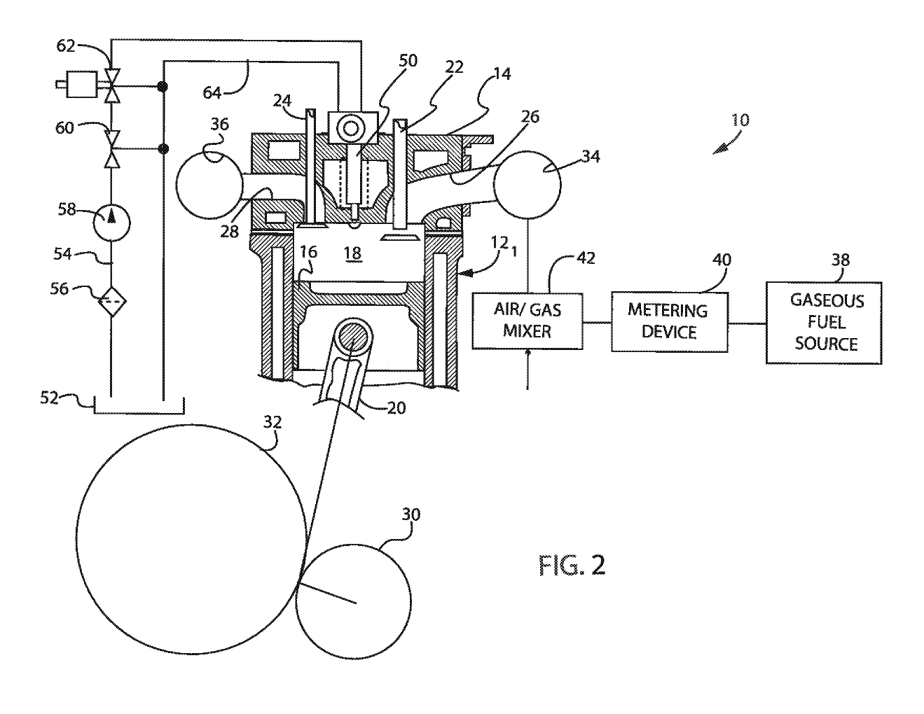

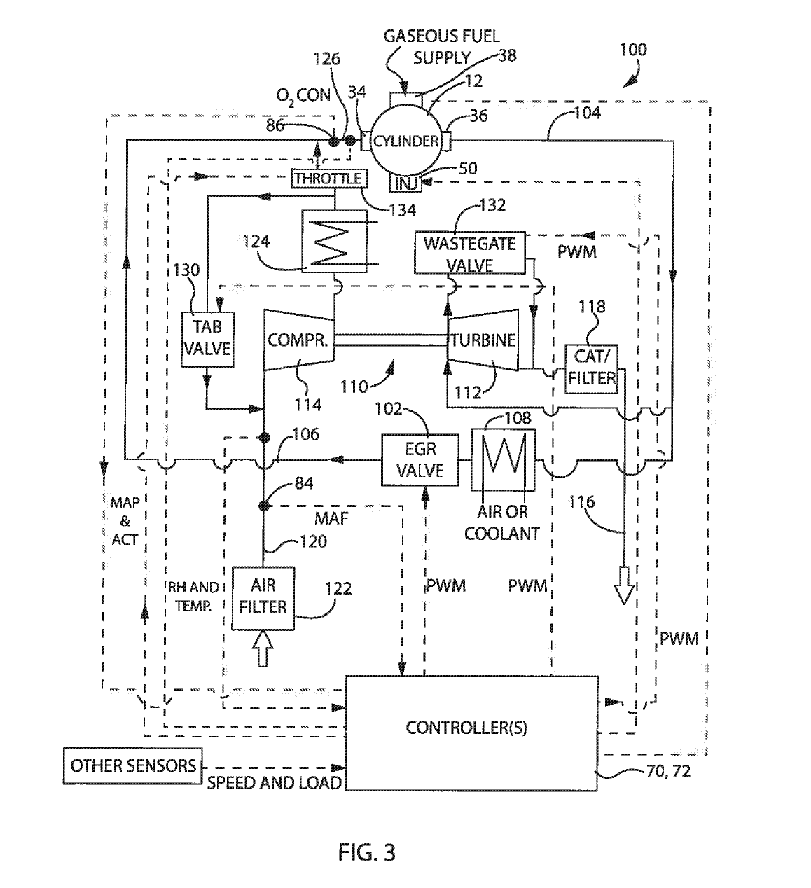

The exemplary engine 10 illustrated in FIGS. 1-2 is a compression ignition-type internal combustion engine having a plurality of cylinders 12, each capped with a cylinder head 14 (FIG. 2). Six cylinders 12₁-12₆ are shown in this embodiment. As is also shown in FIG. 2, a piston 16 is slidably disposed in the bore of each cylinder to define a combustion chamber 18 between the cylinder head 14 and the piston 16. Piston 16 also is connected to a crankshaft 20 in a conventional manner. Inlet and exhaust valves 22 and 24 are provided at the end of respective passages 26 and 28 in the cylinder head 14 and are actuated by a standard camshaft 30 that is rotated by a crankshaft 32 so as to control the supply of an air/fuel mixture to and the exhaust of combustion products from the combustion chamber 18. Gases are supplied to and exhausted from engine 10 via an air intake manifold 34 and an exhaust manifold 36 (FIG. 3), respectively. The engine 10 is also fitted with a gaseous fuel supply system, either in an OEM or a retrofit (conversion) process. The system includes a source 38 of gaseous fuel such as a compressed natural gas (CNG) fuel tank. Other sources, such as liquefied natural gas (LNG) could also be used. The gaseous fuel may be supplied to the cylinders 12₁-12₆ from the source 38 via any suitable mechanism. For instance, one or more separate electronically actuated external injectors could be provided for each cylinder. Injectors of this type are disclosed, for example, in U.S. Pat. No. 5,673,673 and entitled Method and Apparatus for the High Mach Injection of a Gaseous Fuel into an Internal Combustion Engine, the subject matter of which is incorporated herein by reference.

In the illustrated embodiment in which the gaseous fuel supply system is a single point injection system lacking a dedicated injector for each cylinder, the gaseous fuel is supplied to the intake manifold 34 via a fuel metering device 40 and an air/gas mixer 42, which also form part of the gaseous fuel supply system. The fuel metering device 40 may be any suitable electronically controlled actuator capable of supplying gaseous fuel at times and quantities demanded by a gaseous fuel controller 70 (detailed below). One suitable fuel metering device is a gas injector available from the Clean Air Power gas injector, Part No, 619625. The air/gas mixer 42 may be any conventional mixer, such as the one disclosed in U.S. Pat. No. 5,408,978 and entitled Gaseous Fuel Entrainment Device and Method, the subject matter of which is incorporated by reference. Shut off valve(s) and other equipment for controlling the flow of gas to the metering device 40, all of which are known to those skilled in the art, are omitted for the sake of convenience.

Liquid fuel could be supplied to the cylinders 12₁-12₆ via either a pump/nozzle supply system or via a common rail supply system as described, for example, in U.S. Pat. No. 5,887,566, and entitled Gas Engine with Electronically Controlled Ignition Oil Injection, the subject matter of which is incorporated herein by reference. The illustrated engine 10 employs pump/nozzle supply system having multiple electronically controlled liquid fuel injectors 50. Each injector could comprise any electronically controlled injector. Referring to FIGS. 1 and 2, each injector 50 is fed with diesel fuel or the like from a conventional tank 52 via a supply line 54. Disposed in line 54 are a filter 56, a pump 58, a high-pressure relief valve 60, and a pressure regulator 62. A return line 64 also leads from the injectors 50 to the tank 52.

Referring now to FIG. 3, an air intake control system 100 for engine 10 may include (1) an exhaust gas recirculation (EGR) subsystem permitting recirculated exhaust gases to flow from the exhaust manifold 36 to the intake manifold 34 and/or (2) a turbocharger 110 which charges air admitted to the intake manifold 34. The turbocharger 110 includes a turbine 112 and a compressor 114 and is driven by exhaust gases to pressurize air in the conventional manner.

The EGR subsystem has an EGR metering valve 102 located in an EGR return line 104 leading from the exhaust manifold 36 to an air intake passage 126 opening into the intake manifold 34. Valve 102 has an outlet connected to a downstream portion 106 of EGR return line 104. An EGR cooler 108 is provided in the EGR line 104 either upstream or downstream of the EGR valve 102. Exhaust gases that do not flow through the EGR valve flow through or around the turbine 112 en route to an exhaust passage 116. The exhaust in the exhaust passage 116 is treated by one or more catalysts and one or more filters (the combination of all such devices being denoted 118 in FIG. 3) before being exhausted to atmosphere.

Still referring to FIG. 3, intake air is admitted into an intake passage 120, where it is filtered in a filter 122 before being pressurized in the compressor 114 of the turbocharger. The outlet of the compressor 114 may be coupled to the inlet of a high pressure charge air cooler 124. The outlet of the high pressure charge air cooler 124 opens into the intake passage 126 that is downstream of the EGR valve outlet line 106.

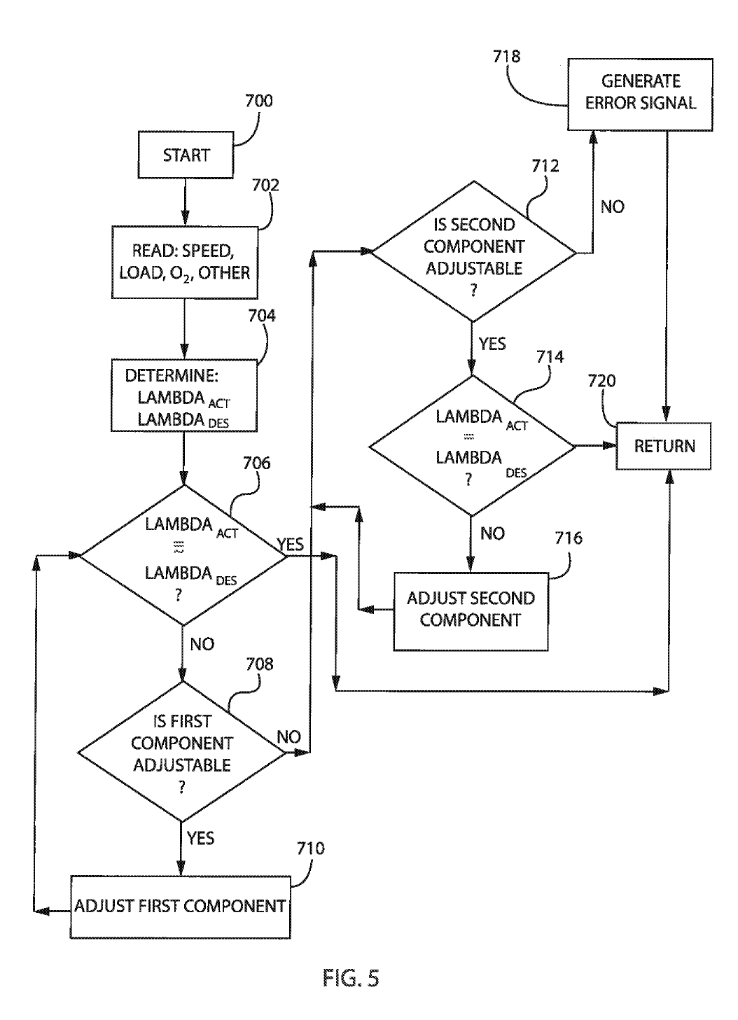

Measures are provided to control A through the control of air flow to the intake manifold 34. In the preferred embodiment, this control may be achieved by controlling a turbo air bypass (TAB) valve 130 and a wastegate valve 132 to optimize the timing and degree of the boost of the turbocharger 110 as described in further detail below with reference to FIG. 5. Both valves 130 and 132 may be either external to or integrated with the turbocharger. Both valves preferably can be adjusted either incrementally or continuously by the controller 68 between a fully opened position and a fully closed position. Turbo boost will be at a maximum when both valves are fully closed and at a minimum when both valves are fully opened. An intake throttle valve 134 may also be provided and controlled instead of or in addition to the TAB valve 130, as discussed in more detail below.

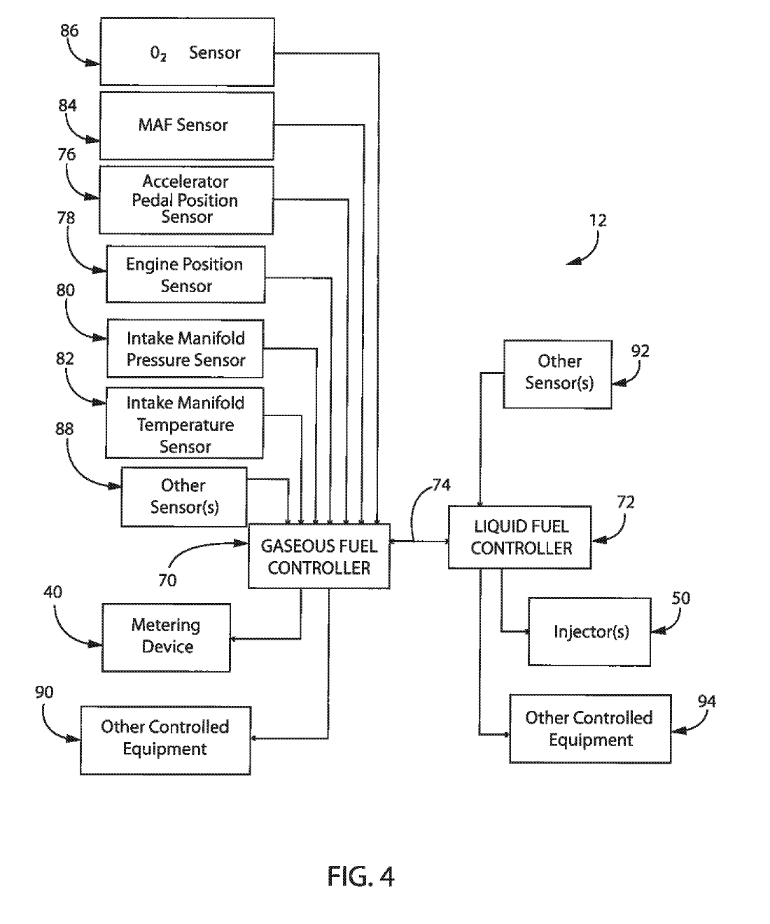

Referring to FIG. 4, the engine control system 68 may be governed either mechanically or electronically. The illustrated engine control system 12 is electronically governed. As shown in FIG. 4, engine operation is controlled by a gaseous fuel controller 70 and a liquid fuel controller 72. The controllers 70 and 72 may be connected to one another by a CAN link or other broadband communications link 14. The controllers 70 and 72 receive data from an accelerator pedal position sensor 76, an engine position sensor 78, an intake manifold pressure sensor 80, an intake manifold temperature sensor 82, a mass air flow (MAF) sensor 84, and an intake O₂ sensor 86. (Several sensors illustrated in FIG. 4 are also denoted in FIG. 3.)

Other sensors, such as an EGR temperature sensor, an ambient pressure sensor, an ambient temperature sensor, a humidity sensor, and a vehicle speed sensor may be provided as well. These sensors are collectively denoted “other sensors” 88 in FIG. 4 and are connected to the gaseous fuel controller 70 by appropriate signal line(s). Still other sensors that are needed only when the engine 10 is operating in diesel-only mode are denoted as 92 and connected to the liquid fuel controller 72. They could alternatively be connected to the gaseous fuel controller 70, in which case the information contained therein would simply be relayed in an unmodified fashion to the liquid fuel controller 72 via the CAN link 74. The gaseous fuel controller 70 also is connected to the gas metering device 40, and to other controlled equipment, such as high-pressure and/or low pressure gas shut off valves, denoted by reference numeral 90. If the engine were a multipoint engine in which an individual gas fuel injector was assigned to each cylinder, those injectors would be controlled by the gaseous fuel controller 70 in lieu of the controlling metering device 40. The liquid fuel controller 72 is connected to each of the injectors 50. It could also control other components of the engine, as denoted by reference numeral 94.

The gaseous fuel controller 70 may be operable to control the liquid fuel controller 72 in a master-slave relationship so as to cause the liquid fuel controller 72 to control the fuel injectors 50 to inject pilot fuel into the cylinders 12₁-12₆ at a timing and quantity that achieve the desired effect at prevailing speed and load conditions. This control need not be with feedback from the liquid fuel controller 72 to the gaseous fuel controller 70. It instead may be performed by intercepting signals that, in an OEM engine, would have been bound for the liquid fuel controller 72 and modifying those signals to effect pilot fuel injection for multi-fuel operation rather than diesel-only injection for diesel-only operation. Alternatively, signals outbound from the liquid fuel controller 72 could be intercepted and modified by the gaseous fuel controller 70 before being transmitted to the diesel injectors. However, in the preferred embodiment in which the liquid fuel controller 72 and gaseous fuel controller 70 are connected to one another by a CAN-link or other broadband communications link 74, more sophisticated communications occur between the controllers 70 and 72. The use of a broadband communications link to facilitate operation of a dual-fuel engine is described in U.S. Pat. No 6,694,242, the contents of which are incorporated herein by reference. One or both of the controllers 70 and 72 could also be linked to additional controllers, such as a vehicle controller that controls other aspects of vehicle operation, by the CAN-link or another link.

Turning now to FIG. 5, a process for sequentially controlling a plurality of components of an air intake system to achieve a desired lambda is shown as beginning at START in Block 700. This process typically will be executed by the gaseous fuel controller 70 based on data received from various sensors as depicted in FIG. 4 but may be controlled in whole or part by another component of engine control system 68. The process controls excess air ratio by sequential control of at least a TAB valve 130 and an electronically controlled turbo wastegate valve 132, as described above. This process preferably is performed on a full speed, full range basis whenever the engine is being fueled at least in part by a gaseous fuel. In the case of a multimode engine in which the engine can also be operated in a diesel-only mode, the process also could be performed while the engine operates in a diesel-only mode. The process proceeds from START in Block 700 to Block 702, where sufficient data is read from the various sensors to permit lambda control to be performed by the remainder of the process. That data may include, for example, an accelerator pedal position signal data received from sensor 76 and indicative of load, engine speed data, intake and/or exhaust O₂ data, etc. Next, in Block 704, engine control system 68 determines, using the data input in Block 702, a parameter indicative of each of a desired lambda value and an actual lambda value for prevailing engine operating conditions. It should be noted that each of the determined parameters could be lambda or a parameter that varies with lambda in a quantifiable manner, such as in-cylinder O₂. For the sake of simplicity, that parameter is referenced in FIG. 5, and hereafter in this discussion, simply as “lambda.”

In Block 706, the actual lambda (LAMBDA_{ACT}) is compared to the desired lambda (LAMBDA_{DES}) to determine if the desired lambda deviates from the actual lambda and, thus, whether lambda adjustment is required. If so, the process proceeds to Blocks 708 and 710, where engine control system 68 transmits a control signal to a first component of the air intake system to increase or decrease lambda. The first component may be either TAB valve 130 or the wastegate valve 132. In a preferred embodiment, the TAB valve 130 is controlled first, assuming it is available for control. That may not be the case, for example, if the TAB valve 130 is fully closed and additional boost is required to increase lambda. This control preferably takes place incrementally in a closed loop.

Specifically, the process first determines whether adjustment of the first component is possible in Block 708. Assuming adjustment is possible, the process proceeds to Block 710 and incrementally adjusts the first component (the TAB valve in this example), and then returns to Block 706 to determine whether the adjustment was sufficient to achieve the desired effect. If not, the process cycles through Blocks 706, 708, and 710 until the actual lambda at least approximately equals the desired lambda, whereupon the process proceeds to RETURN in Block 720.

If adjustment of the first controlled component is not possible during this control, either initially or at any point in the feedback process, the process then resorts to sequential control of the second component as illustrated by Blocks 712-716. For example, if the TAB valve 130 is fully closed at any time during the execution of Blocks 706-710 and additional turbo boost is still required, the process proceeds to Block 712 to determine whether it is possible to adjust the second component, such as by incrementally closing the turbo wastegate. If so, the process again queries in Block 714 whether lambda adjustment is required, which would be the case whenever the process proceeds directly from Block 708 to Block 712 but otherwise may not be the case. If lambda adjustment is required, the process proceeds to Block 716 where second component is adjusted incrementally in the desired direction, and the process returns to the inquiry Block 712 to determine whether actual lambda at least approximately equals the desired lambda. The process cycles through Blocks 712-716 until the actual lambda at least approximately equals the desired lambda, whereupon the process proceeds to RETURN in Block 720.

If, in the unlikely event the second controlled component exceeds its range of adjustment without the desired lambda value being achieved, the process receives a negative answer to the inquiry of Block 712 and generates a signal to that effect in Block 718. That signal can be used, for example, to generate an error message or to trigger additional controls such as control of an EGR valve. The process then proceeds to RETURN in Block 720.

While the example described above describes a sequential control scheme in which TAB valve control is followed by wastegate valve control in order to avoid turbo lag, it should be clear from the discussion as whole that the wastegate valve could be the first controlled component in a sequential control process. This control might be preferred, at least during steady state operation, if, for example, fuel economy were of paramount concern.

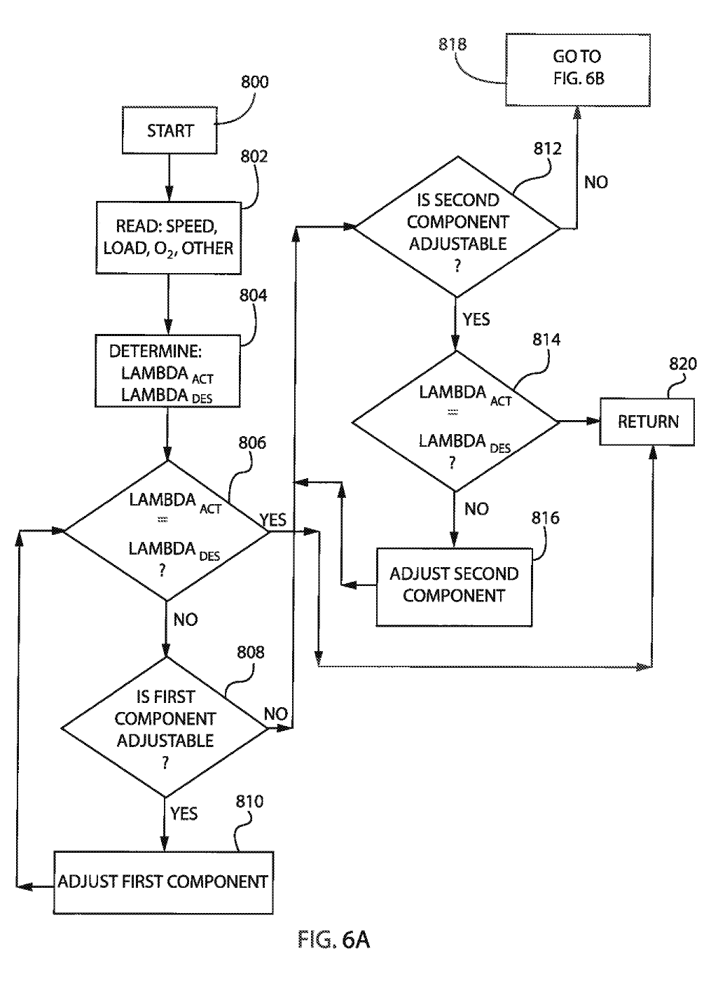

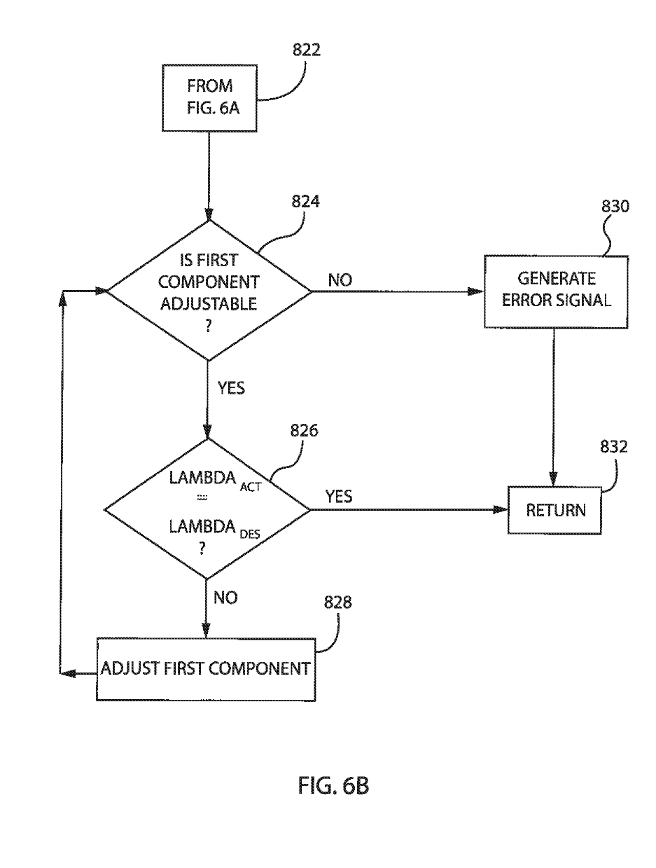

It should be noted that other components could be used to adjust airflow instead of or in addition to one or both of the TAB valve 130 and the wastegate valve 132. For example, the throttle valve 134 could be controlled instead of, or possibly in addition to, controlling the TAB valve 130. If it were to be controlled in addition to controlling the TAB valve 130, the throttle valve 134 could be controlled sequentially with the valves 130 and 132, This control, is illustrated in the flowchart of FIGS. 6A and 6R As indicated by Blocks 800-816 and 820, the routine shown in this flowchart includes the same sequential control of first component (such as the TAB valve 130) followed by the second component (such as the wastegate valve 132) as described above. However, rather than generating an error signal in Block 818 of FIG. 6A if control of the second component is insufficient to achieve the desired effect, the routine proceeds to the portion of the process designated by Block 822 in FIG. 6B. It then initiates sequential control of the third component as illustrated by Blocks 824-828 and proceeds to return in Block 832 when the desired effect is achieved. The third component may be the throttle valve 134 of FIG. 3 or some other component. An error signal or similar response is generated in Block 830 only if it is determined in Block 824 that no adjustment of the third component is possible.

In addition, while the airflow control processes have been described herein in conjunction with lambda control, they could be used to control other aspects of engine operation that depend, at least in part, on the airflow into the air intake manifold of an engine.

To the extent that they might not be apparent from the above, the scope of variations falling within the scope of the present invention will become apparent from the appended claims.

We claim:

1. A method of controlling components in an air intake system for a gaseous fueled compression ignition internal combustion engine, the method comprising:
(A) delivering an air/fuel charge to the engine that includes at least air and a gaseous fuel, the air/fuel charge having an excess air ratio (lambda);
(B) sequentially controlling the operation of a plurality of components in an air intake system to control lambda, including
i. identifying a deviation between an actual value of a parameter indicative of lambda and a desired value of the parameter;
ii. controlling a first component of the air intake system so as to partially compensate for the deviation, and then
iii. controlling a second component of the air intake system to further compensate for the deviation.

2. The method of claim 1, wherein the first component is a turbo air bypass valve and the second component is a wastegate valve.

3. The method of claim 1, wherein the first component is a wastegate valve and the second component is a turbo air bypass valve.

4. The method of claim 1, wherein the controlling steps comprise adjusting the first component a maximum available amount and then adjusting the second component only if the adjustment of the first component fails to compensate for the deviation.

5. The method of claim 1, wherein the desired value of the parameter is determined based on a current engine load and a current engine speed.

6. The method of claim 1, further including, either before or after controlling the second component of the air intake system, controlling a third component in the air intake system to at least partially compensate for the deviation.

7. The method of claim 6, wherein the third component is a throttle.

8. The method of claim 1, wherein the method is performed on a full speed, full range basis whenever the engine is being fueled at least in part by a gaseous fuel.

9. An internal combustion engine, the engine comprising:
i. a plurality of cylinders;
ii. a gaseous fuel delivery system that delivers a selected volume of gaseous fuel to the cylinders;
iii. a liquid fuel delivery system that delivers a selected volume of liquid fuel to the cylinders;
iv. an intake control system that controls the flow of air; and
v. at least one controller coupled to the gaseous fuel delivery system, the liquid fuel delivery system, and the air intake control system to
1. fuel the internal combustion engine in a mode in which the engine is fueled by a charge of the gaseous fuel, air, and the liquid fuel, the charge having an excess air ratio (lambda);
2. identify a deviation between an actual value of a parameter indicative of lambda and a desired value of the parameter;
3. control a first component of the air intake system so as to partially compensate for the deviation, and then
4. control a second component of the air intake system to further compensate for the deviation.

10. The system of claim 9, wherein the first component is a turbo air bypass valve and the second component is a wastegate valve.

11. The system of claim 9, wherein the first component is a wastegate valve and the second component is a turbo air bypass valve.

12. The method of claim 9, wherein the at least one controller is operable to adjust the first component a maximum available amount and to then adjust the second component only if the adjustment of the first component fails to compensate for the deviation.

13. The system of claim 9, wherein the at least one controller is operable, after the control of the second component, to control a third component of the air intake system to at least partially compensate for the deviation.

14. The system of claim 13, wherein the third component is a throttle.
